(19) United States
(12) Patent Application Publication
(10) Pub. No.: US 2019/0350426 A1
(43) Pub. Date: Nov. 21, 2019

(54) METHOD AND DEVICE FOR DETECTING MOVING DISTANCE, AND STORAGE MEDIUM

(71) Applicants: JIANGSU MIDEA CLEANING APPLIANCES CO., LTD., Suzhou (CN); MIDEA GROUP CO., LTD., Foshan (CN)

(72) Inventors: Jongsik WOO, Suzhou (CN); Haiyan JIN, Suzhou (CN)

(21) Appl. No.: 16/125,794

(22) Filed: Sep. 10, 2018

Related U.S. Application Data
(63) Continuation of application No. PCT/CN2018/098023, filed on Aug. 1, 2018.

(30) Foreign Application Priority Data
May 21, 2018 (CN) 201810490173.4

(51) Int. Cl. A47L 11/40; G05D 1/02

(52) U.S. Cl. CPC A47L 11/4011; A47L 2201/04; G05D 1/0219; G05D 1/0272

(57) ABSTRACT

Disclosed are a method and a device for detecting a moving distance and a storage medium. The method is applied to an automatic cleaning device including a moving wheel, in which the moving wheel includes a disk magnet disposed at a pivot center of the moving wheel and configured to rotate along with the moving wheel; the disk magnet includes at least one set of magnets, each set of magnets having two corresponding poles; the moving wheel further includes a Hall sensor configured to monitor a change amount of a magnetic field strength of each set of magnets in the disk magnet, and a movement trajectory of the Hall sensor is parallel to and synchronized with a movement trajectory of the pivot center of the moving wheel; the method includes: monitoring the change amount of the magnetic field strength of each set of magnets in the disk magnet, and outputting N pulse waveforms according to the change amount of the magnetic field strength of each set of magnets, wherein a value of N is associated with a rotation arc of the moving wheel, and N is a positive number, determining a rotation arc of the disk magnet according to the N pulse waveforms, and determining a moving distance of the moving wheel according to the rotation arc of the disk magnet.

### CROSS-REFERENCE TO RELATED APPLICATION

This application is a continuation of International Application No. PCT/CN2018/098023, filed on Aug. 1, 2018, which claims a priority to and benefits of Chinese Patent Application Serial No. 201810490173.4, filed with the State Intellectual Property Office of P. R. China on May 21, 2018, the entire content of which is incorporated herein by reference.

### FIELD

The present disclosure relates to a field of household appliance detecting techniques, and more particularly to a method and a device for detecting a moving distance, and a computer-readable storage medium.

### BACKGROUND

Movement of a robot cleaner is realized by a moving wheel arranged in the robot cleaner. An accuracy of detecting a moving distance of the robot cleaner is an important element required to control a posture, estimate a position and draw a working map of the robot cleaner. A problem of low accuracy of detecting the moving distance of the moving wheel is currently needed to be solved. The moving wheel of the existing robot cleaner is generally equipped with a wheel encoder configured to detect the rotation amount of the motor connected to the moving wheel and determine the moving distance of the robot cleaner according to the rotation amount, thus providing basic information required for positioning the robot cleaner and producing the map.

In the existing methods, in order to improve the accuracy of the moving distance, the number of Hall sensors is generally increased and 2\hat{ }K phases may be distinguished by K Hall sensors to achieve a high-accuracy measurement. However, it is difficult to choose spatial positions for the Hall sensors and the price of the Hall sensor is relatively high, problems of difficulties in improving the detection accuracy of the moving distance and high cost still exist.

### SUMMARY

In order to solve the problems existing in the related art, embodiments of the present disclosure provide a method and a device for detecting a moving distance, and a computer-readable storage medium.

Technical solutions of the present disclosure are realized as follows.

Embodiments of the present disclosure provide a method for detecting a moving distance, applied to an automatic cleaning device including a moving wheel, in which the moving wheel includes a disk magnet disposed at a pivot center of the moving wheel and configured to rotate along with the moving wheel; the disk magnet includes at least one set of magnets, each set of magnets having two corresponding poles; the moving wheel further includes a Hall sensor configured to monitor a change amount of a magnetic field strength of each set of magnets in the disk magnet, and a movement trajectory of the Hall sensor is parallel to and synchronized with a movement trajectory of the pivot center of the moving wheel; the method includes:

monitoring the change amount of the magnetic field strength of each set of magnets in the disk magnet, and outputting N pulse waveforms according to the change amount of the magnetic field strength of each set of magnets, in which a value of N is associated with a rotation arc of the moving wheel, and N is a positive number,

determining a rotation arc of the disk magnet according to the N pulse waveforms, and

determining a moving distance of the moving wheel according to the rotation arc of the disk magnet.

In an embodiment of the present disclosure, determining a rotation arc of the disk magnet according to the N pulse waveforms includes:

determining a rotation direction of the moving wheel according to a voltage value corresponding to the N pulse waveforms, in which the rotation direction includes a forward rotation direction and a reverse rotation direction;

determining a first rotation arc when the moving wheel rotates in the forward rotation direction and a second rotation arc when the moving wheel rotates in the reverse rotation direction;

adding the first rotation arc to the second rotation arc to obtain a result and taking the result as the rotation arc of the moving wheel.

In an embodiment of the present disclosure, determining a first rotation arc when the moving wheel rotates in the forward rotation direction and a second rotation arc when the moving wheel rotates in the reverse rotation direction includes:

inquiring a stored correspondence relationship between pulse waveforms and rotation arcs according to the N pulse waveforms and determining the first rotation arc corresponding to a pulse waveform generated when the moving wheel rotates in the forward rotation direction and the second rotation arc corresponding to a pulse waveform generated when the moving wheel rotates in the reverse rotation direction in the N pulse waveforms.

In an embodiment of the present disclosure, before inquiring a stored correspondence relationship between pulse waveforms and rotation arcs according to the N pulse waveforms, the method further includes:

determining the number of sets of the magnets, and determining the correspondence relationship between the pulse waveforms and the rotation arcs according to the number of sets of the magnets.

In an embodiment of the present disclosure, determining a moving distance of the moving wheel according to the rotation arc of the disk magnet includes:

determining a radius of the moving wheel, and determining the moving distance of the moving wheel according to the radius of the moving wheel and the rotation arc of the disk magnet.

Embodiments of the present disclosure further provide an apparatus for detecting a moving distance, applied to an automatic cleaning device including a moving wheel, in which the moving wheel includes a disk magnet disposed at a pivot center of the moving wheel and configured to rotate along with the moving wheel; the disk magnet includes at least one set of magnets, each set of magnets having two corresponding poles; the moving wheel further includes a Hall sensor configured to monitor a change amount of a magnetic field strength of each set of magnets in the disk magnet, and a movement trajectory of the Hall sensor is parallel to and synchronized with a movement trajectory of the pivot center of the moving wheel; the apparatus includes a first determining module and a second determining module, in which

the first determining module is configured to monitor the change amount of the magnetic field strength of each set of magnets in the disk magnet, and output N pulse waveforms according to the change amount of the magnetic field strength of each set of magnets, in which a value of N is associated with a rotation arc of the moving wheel, and N is a positive number,

the second determining module is configured to determine a rotation arc of the disk magnet according to the N pulse waveforms, and determine a moving distance of the moving wheel according to the rotation arc of the disk magnet.

In an embodiment of the present disclosure, the second determining module is specifically configured to determine a rotation direction of the moving wheel according to a voltage value corresponding to the N pulse waveforms, in which the rotation direction includes a forward rotation direction and a reverse rotation direction; determine a first rotation arc when the moving wheel rotates in the forward rotation direction and a second rotation arc when the moving wheel rotates in the reverse rotation direction; add the first rotation arc to the second rotation arc to obtain a result and take the result as the rotation arc of the moving wheel.

In an embodiment of the present disclosure, the second determining module is specifically configured to inquire a stored correspondence relationship between pulse waveforms and rotation arcs according to the N pulse waveforms and determine the first rotation arc corresponding to a pulse waveform generated when the moving wheel rotates in the forward rotation direction and the second rotation arc corresponding to a pulse waveform generated when the moving wheel rotates in the reverse rotation direction in the N pulse waveforms.

In an embodiment of the present disclosure, the second determining module is further configured to determine the number of sets of the magnets and determine the correspondence relationship between the pulse waveforms and the rotation arcs according to the number of sets of the magnets.

In an embodiment of the present disclosure, the second determining module is specifically configured to determine a radius of the moving wheel, and determine the moving distance of the moving wheel according to the radius of the moving wheel and the rotation arc of the disk magnet.

Embodiments of the present disclosure further provide a device for detecting a moving distance, including a processor; a memory having stored therein computer programs executable on the processor, in which when the computer programs are executed by the processor, the processor is configured to perform a method described above.

Embodiments of the present disclosure further provide a computer-readable storage medium having stored therein computer programs that, when executed by a processor, cause the processor to perform a method described above.

The method and device for detecting the moving distrance and the computer-readable storage medium provided by embodiments of the present disclosure are applied to the automatic cleaning device including the moving wheel. The moving wheel includes a disk magnet disposed at a pivot center of the moving wheel and configured to rotate along with the moving wheel; the disk magnet includes at least one set of magnets, each set of magnets having two corresponding poles; the moving wheel further includes a Hall sensor configured to monitor a change amount of a magnetic field strength of each set of magnets in the disk magnet, and a movement trajectory of the Hall sensor is parallel to and synchronized with a movement trajectory of the pivot center of the moving wheel. The technical solution of the present disclosure includes: monitoring the change amount of the magnetic field strength of each set of magnets in the disk magnet, and outputting N pulse waveforms according to the change amount of the magnetic field strength of each set of magnets, in which a value of N is associated with a rotation arc of the moving wheel, and N is a positive number, determining a rotation arc of the disk magnet according to the N pulse waveforms, and determining a moving distance of the moving wheel according to the rotation arc of the disk magnet. In the solution according to embodiments of the present disclosure, the moving distance of the moving wheel can be detected accurately without increasing the number of the Hall sensors or the magnets.

### BRIEF DESCRIPTION OF THE DRAWINGS

FIG. 1(a) is a schematic diagram of an 8-pole disk magnet provided with a Hall sensor;

FIG. 1(b) is a schematic diagram showing hysteresis;

FIG. 2 is a schematic diagram of a magnetic field strength of an 8-pole disk magnet provided with a Hall sensor;

FIG. 3 is a flow chart of a method for detecting a moving distance according to an embodiment of the present disclosure;

FIG. 4 is a schematic diagram showing determining a moving distance according to a magnetic field strength provided in an embodiment of the present disclosure;

FIG. 5 is a schematic block diagram of a detection system of a moving distance according to an embodiment of the present disclosure;

FIG. 6 is a schematic block diagram of an apparatus for detecting a moving distance according to an embodiment of the present disclosure; and

FIG. 7 is a schematic block diagram of a device for detecting a moving distance according to an embodiment of the present disclosure.

### DETAILED DESCRIPTION

In embodiments of the present disclosure, a change amount of a magnetic field strength of each set of magnets in a disk magnet is monitored, and N pulse waveforms are output according to the change amount of the magnetic field strength of each set of magnets, in which a value of N is associated with a rotation arc of a moving wheel, and N is a positive number. A rotation arc of the disk magnet is determined according to the N pulse waveforms. A moving distance of the moving wheel is determined according to the rotation arc of the disk magnet.

Firstly, a method of detecting a moving distance with a wheel encoder is described below.

The moving wheel of a robot cleaner is typically equipped with a motor, a disk magnet and a Hall sensor. Specifically, the motor is configured to drive the moving wheel to rotate, and the disk magnet and the Hall sensor are configured to detect a rotation amount of the moving wheel. The disk magnet generally includes from 12 poles to 36 poles, and the rotation amount is detected by using two or more Hall sensors in view of accuracy. The detecting method may include following steps. A magnetic field of a south/north (S/N) pole in a plurality of magnets is detected and a pulse is output. A single rotation motion may be a 360-degree rotation being divided into 6 to 18 (i.e., dividing 12 by 2 to dividing 36 by 2) parts in an accuracy in view of the pulse. Two Hall sensors are used and 4 phases are distinguished, such that the 360-degree rotation may be divided in 24 to 72 (i.e., multiplying 6 by 4 to multiplying 18 by 4) parts in an accuracy in view of the phase, that is, one phase corresponds to a rotation movement of 15° to 5°.

In order to improve the detection accuracy, the number of poles of the disk magnet can be increased or multiple Hall sensors can be added to further refine the phase, thus improving the detection accuracy. However, in the case that the number of poles of the disk magnet is increased, a size of the disk magnet will be enlarged since the magnitude of the detected magnetic force is proportional to the volume of m/2 (m is the number of poles) magnets. In the case that multiple Hall sensors are adopted, it is difficult to distribute the multiple Hall sensors considering the position of the S/N poles of the disk magnet. Moreover, in a mass production, actual lengths of printed circuit boards (PCBs) are different, and thus products may have different phases, which are difficult to become identical. In addition, the price of the Hall sensor is relatively high.

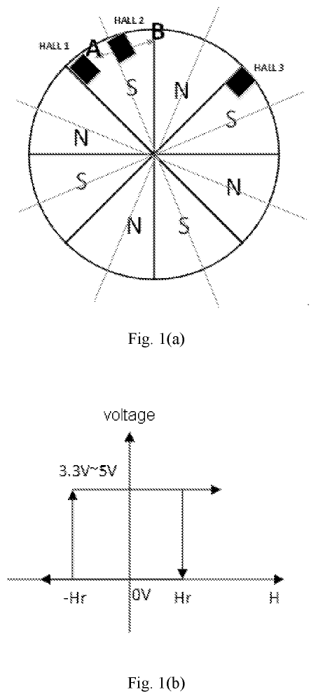

FIG. 1(a) is a schematic diagram of an 8-pole disk magnet provided with a Hall sensor. As shown in FIG. 1(a), two Hall sensors are assigned to four magnetic phases of a disk magnet having eight magnetic poles. The two Hall sensors have different output phases, and a 90° phase difference between the two output values is required.

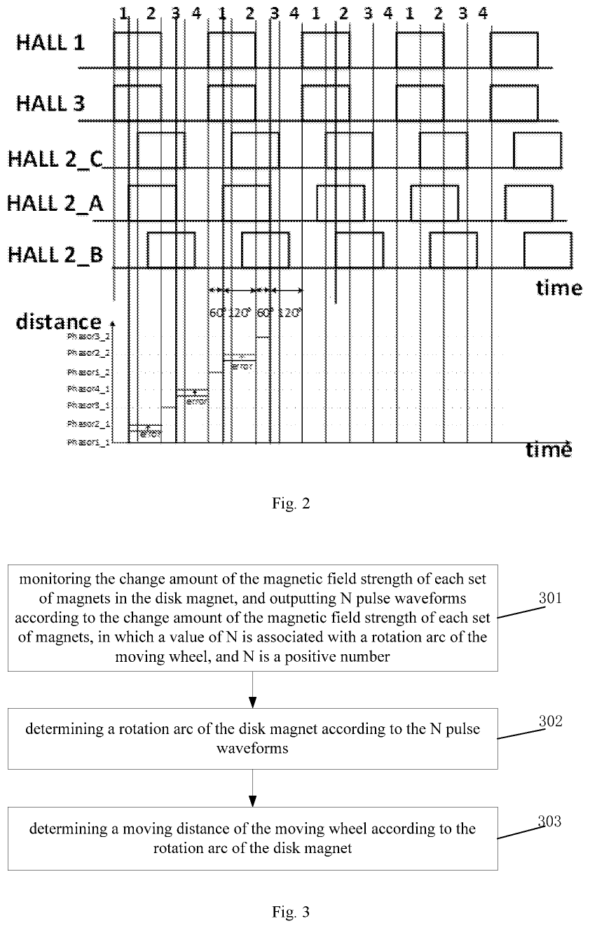

With reference to FIG. 1(a), if the position of the first Hall sensor is determined to be HALL1 and the position of the second Hall sensor is at HALL2, there is a phase difference of 90° between the outputs of the two Hall sensors and the moving distance is calculated by using four distinguished phases. If the position of the first Hall sensor is determined to be HALL1 and the position of the second Hall sensor is at HALL3, the output values of the Hall sensors located at HALL1 and HALL3 are the same and thus there is no phase difference. In this case, one Hall sensor will be meaningless, and specific parameters are shown in FIG. 2. In addition, as shown in FIG. 2, output values of the Hall sensor in a position of HALL2_A or in a position of HALL2_B which is relatively far away are taken as an example and it is assumed that the first phase is 60°, the second phase is 120°, the third phase is 60° and the fourth phase is 120° which are different from each other, resulting in an error in the detection of the moving distance in each phase region. Moreover, the pulse may not be output by the Hall sensor at an N/S switching point, a hysteresis phenomenon may occur due to the delay, which is shown in FIG. 1(b). Therefore, when a plurality of Hall sensors are used to detect magnetic field strengths of different phase regions, accurate and complete pulses for different phase regions cannot be acquired.

As described above, it is difficult for the existing robot cleaner to identify an accurate 90° phase difference. Actions of the four phases are different, and the moving distance detected by each section is stepped, such that the moving distance cannot be accurately detected.

FIG. 3 is a flow chart of a method for detecting a moving distance according to an embodiment of the present disclosure. The method is applied to an automatic cleaning device (such as a device including a moving wheel, e.g., a robot cleaner), and the automatic cleaning device include a moving wheel. The moving wheel includes a disk magnet disposed at a pivot center of the moving wheel and configured to rotate along with the moving wheel. The disk magnet includes at least one set of magnets, and each set of magnets has two corresponding poles.

The moving wheel further includes a Hall sensor configured to monitor a change amount of a magnetic field strength of each set of magnets in the disk magnet, and a movement trajectory of the Hall sensor is parallel to and synchronized with a movement trajectory of the pivot center of the moving wheel.

As shown in FIG. 3, the method include following steps.

At step 301, the change amount of the magnetic field strength of each set of magnets in the disk magnet is monitored, and N pulse waveforms according to the change amount of the magnetic field strength of each set of magnets are output, in which a value of N is associated with a rotation arc of the moving wheel, and N is a positive number.

The pulse waveform represents a voltage value corresponding to the magnetic field strength herein.

In some embodiments, the moving wheel of the automatic cleaning device includes at least one Hall sensor.

In the step 301, it is included that the change amount of the magnetic field strength of each set of magnets in the disk magnet is monitored by the Hall sensor, and N pulse waveforms according to the change amount of the magnetic field strength of each set of magnets are output.

The automatic cleaning device may further include a processor configured to detect the moving distance of the automatic cleaning device.

In some embodiments, the step 301 may further include following steps.

The change amount of the magnetic field strength of each set of magnets in the disk magnet is monitored by the Hall sensor. The processor receives the change amount of the magnetic field strength and performs an analog-to-digital conversion on the change amount of the magnetic field strength, thus acquiring N pulse waveforms representing the change amount of the magnetic field strength.

In some embodiments, the detected magnetic field strength may be sent to the processor from the Hall sensor and the processor performs the analog-to-digital (AD) conversion on the magnetic field strength to acquire a voltage waveform representing the change of the magnetic field strength. The voltage waveform presents in a form of pulse waveform (specifically, a sine waveform).

The processor may be realized by a central processing unit (CPU), a digital signal processor (DSP), a micro control unit (MCU) or a field-programmable gate array (FPGA).

At step 302, a rotation arc of the disk magnet is determined according to the N pulse waveforms.

In some embodiments, determining a rotation arc of the disk magnet according to the N pulse waveforms includes:

determining a rotation direction of the moving wheel according to a voltage value corresponding to the N pulse waveforms, in which the rotation direction includes a forward rotation direction and a reverse rotation direction;

determining a first rotation arc when the moving wheel rotates in the forward rotation direction and a second rotation arc when the moving wheel rotates in the reverse rotation direction by the processor;

adding the first rotation arc to the second rotation arc to obtain a result and taking the result as the rotation arc of the moving wheel.

In some embodiments, the forward rotation and the reverse rotation may happen when the moving wheel rotates, and thus the rotation direction of the moving wheel should be determined. Herein, two manners are described for determining the rotation direction of the moving wheel.

The first manner: a driving instruction sent by the processor to control the direction of the moving wheel is received, and the rotation direction of the moving wheel is determined according to the driving instruction.

The second manner: a rotation direction of the moving wheel is determined according to the voltage waveform. In some embodiments, it can be preset by the processor that a positive voltage value indicates a forward rotation and a negative voltage value indicates a reverse rotation, such that the rotation direction of the moving wheel may be determined by the voltages corresponding to the N pulse waveforms.

The processor is further configured to determine a switching point of the forward rotation and the reverse rotation, and the determining method includes following steps. The magnetic field strengths detected by the Hall sensor are sequentially input into the processor. After the digital-to-analog conversion is performed on the magnetic field strengths by the processor, the pulse waveform is acquired. When it is determined by the processor according to the pulse waveform that a product multiplying a current voltage value by a voltage value one second before is less than or equal to zero, as shown in formula (1), zero crossing occurs. The zero crossing means a transition from the forward rotation to the reverse rotation or from the reverse rotation to the forward rotation.

$$f ( V ( i ) ) = \{ \begin{matrix}0 , & {V}_{i} \times {V}_{i + 1} > 0 \\ 1 , & {V}_{i} \times {V}_{i + 1} \leq 0\end{matrix} \qquad ( 1 )$$

in which, f(V(0)=1, at zero crossing, represents a time point, and the Vᵢ represents a detected voltage value.

The pulse waveform is determined according to the rotation direction and the zero crossing point by the processor, thus determining a first rotation arc when the moving wheel rotates in the forward direction and a second rotation arc when the moving wheel rotates in the reverse direction.

In some embodiments, determining a first rotation arc when the moving wheel rotates in the forward rotation direction and a second rotation arc when the moving wheel rotates in the reverse rotation direction includes:

inquiring a stored correspondence relationship between pulse waveforms and rotation arcs according to the N pulse waveforms and determining the first rotation arc corresponding to a pulse waveform generated when the moving wheel rotates in the forward rotation direction and the second rotation arc corresponding to a pulse waveform generated when the moving wheel rotates in the reverse rotation direction in the N pulse waveforms.

In some embodiments, before inquiring a stored correspondence relationship between pulse waveforms and rotation arcs according to the N pulse waveforms, the method further includes:

determining the number of sets of the magnets, and determining the correspondence relationship between the pulse waveforms and the rotation arcs according to the number of sets of the magnets.

In some embodiments, a disk magnet with M (M is a multiple of 2) poles is disposed on the moving wheel to measure the rotation angle of the moving wheel. When the moving wheel rotates 360°, i.e., one cycle, M/2 complete pulse waveforms are detected by the Hall sensor, that is, a complete pulse waveform equivalents to a rotation angle of 360°/M/2, and the rotation angle of 360°/M/2 is converted into radians (1 radian=180°/π), such that a correspondence relationship between pulse waveforms and rotation arcs may be determined. According to the above description, the correspondence relationship between the pulse waveforms and the rotation arcs meets formula (2) shown as follows.

$${θ}_{i} = \{ \begin{matrix}arcsin ( \frac{{V}_{i}}{A} ) , & if {V}_{i} \leq {V}_{i + 1} \\ ( π - arcsin ( \frac{{V}_{i}}{A} ) , & if {V}_{i} > {V}_{i + 1}\end{matrix} \qquad ( 2 )$$

in which θᵢ represents a rotation arc in radians, i represents a time point, Vᵢ represents a voltage value of the i^{th} second, and A represents a peak value of a sinusoidal waveform.

It should be noted that when it is determined by the processor that the acquired pulse waveform includes X complete sine waveforms,

$${θ}_{i} = ( arcsin ( \frac{{V}_{i}}{A} ) + 2 X π ) , if {V}_{i} \leq {V}_{i + 1} .$$

At step 303, a moving distance of the moving wheel is determined according to the rotation arc of the disk magnet.

In some embodiments, the step 303 includes determining a radius of the moving wheel by the processor, and determining the moving distance of the moving wheel according to the radius of the moving wheel and the rotation arc of the disk magnet.

In some embodiments, the moving distance=R*θi, in which R represents the radius of the moving wheel, and θi represents a rotation arc. Specifically, θi=2*π*angle°/360°, the angle° represents a rotation angle in degrees.

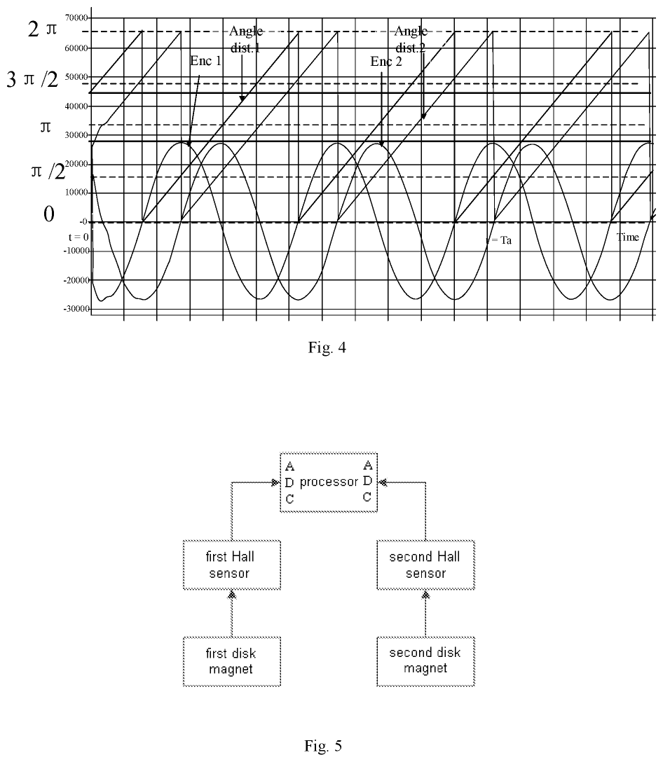

FIG. 4 is a schematic diagram showing determining a moving distance according to a magnetic field strength provided in an embodiment of the present disclosure. As shown in FIG. 4, a moving wheel including a disk magnet with M poles (M=8) is taken as an example, and it is assumed that each moving wheel is provided with a processor (in actual practice, moving wheels from the same automatic cleaning device may share one processor). At t=0, an initial value of a first moving wheel is 60°, and an initial value of a second moving wheel is 90°. The two moving wheels rotate simultaneously, and a distance (when t=ta) of the movement of the moving wheel may be determined.

In some embodiments, the output value of the waveform measured by the processor of the first moving wheel, i.e., Enc1, at t=0 is equivalent to A sin 240°, and the output value of the waveform measured by the processor of the second moving wheel, i.e., Enc2, at t=0 is equivalent to A sin 150°. Herein, one sinusoidal waveform is equivalent to a rotation angle of 360°/8/2. According to the sinusoidal waveform of the processor of the first moving wheel, the rotation angle can be calculated as {(360°−240°)+360°*2+90°}/8/2. According to the sinusoidal waveform of the processor of the second moving wheel, the rotation angle can be calculated as {(360°-150°)+360° *2}/8/2. The rotation arc is determined by the rotation angle, and the moving distance of the moving wheel may be determined according to the rotation arc in combination with a radius of the moving wheel. Triangular waves (Angle dist. 1 and Angle dist. 2) in the FIG. 4, i.e., Arcsin functions, indicate the corresponded rotation arcs and thus the triangular waves may be used to determine the moving distance of the moving wheel quickly.

It should be noted that, in order to quickly determine the Arcsin value corresponding to an angle, an infinite number of Arcsin values may be stored in the processor in an embodiment of the present disclosure. Specifically, 180 Arcsin values from 0° to 90° with an interval of 0.5° or 90 Arcsin values from 0° to 90° with an interval of 1° are stored in the processor, and other values of corresponding angles can be calculated according to the symmetrical characteristics of the sine function. A way to determine the Arcsin value may be as follows. A part of Arcsin values corresponding to a rotation angle ranged from 0° to 90° are stored, and a measured intermediate value is interpolated by using the stored values and an interpolation filter. During the interpolation realized by using the stored values and the interpolation filter, for a function f (x) with a real variable x, when two or more function values f (xi) (i=1, 2, . . . ) with a certain shape and a certain interval are known, any f (x) in this section can be calculated. Unobserved values can be inferred from the unpredicted function according to the predictions obtained from experiments or observations. In the embodiment, due to expansion of the function, in the neighborhood between the variables x0 and x1, polynomial interpolation may be calculated by an approximate expression function of the function f (x), i.e.,

$$f ( x ) = f ( {x}_{0} ) + \frac{f ( {x}_{1} ) - f ( {x}_{0} )}{{x}_{1} - {x}_{0}} ( x - {x}_{0} ) .$$

FIG. 5 is a schematic block diagram of a detection system of a moving distance according to an embodiment of the present disclosure. As shown in FIG. 5, the system includes a processor, a first disk magnet and a first Hall sensor provided in the first moving wheel and a second disk magnet and a second Hall sensor provided in the second moving wheel. The first Hall sensor is configured to acquire the magnetic field strength of the first disk magnet and the second Hall sensor is configured to acquire the magnetic field strength of the second disk magnet. The acquired magnetic field strengths are sent to the processor, and the processor is configured to perform the digital-to-analog conversion to the magnetic field strengths. The moving distance of each moving wheel is thus determined according to the change amount of the magnetic field strength as described in the method shown in FIG. 3.

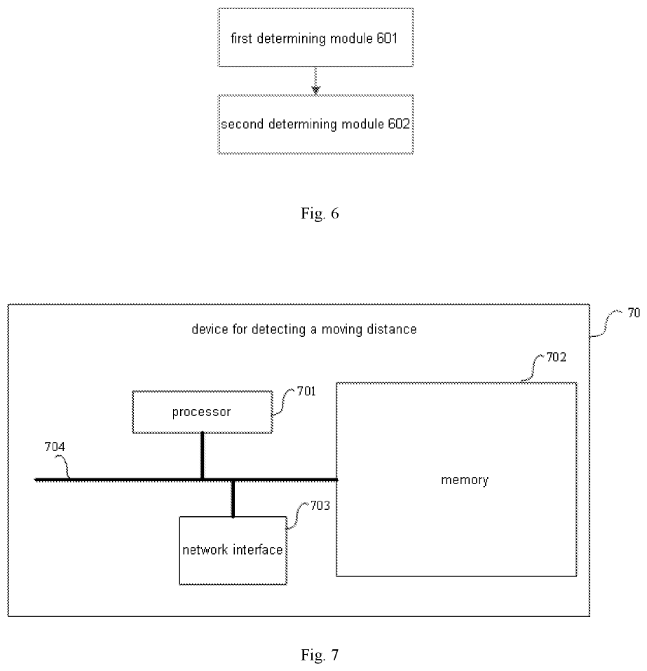

FIG. 6 is a schematic block diagram of an apparatus for detecting a moving distance according to an embodiment of the present disclosure. As shown in FIG. 6, the apparatus is applied to an automatic cleaning device including a moving wheel, in which the moving wheel includes a disk magnet disposed at a pivot center of the moving wheel and configured to rotate along with the moving wheel; the disk magnet includes at least one set of magnets, each set of magnets having two corresponding poles; the moving wheel further includes a Hall sensor configured to monitor a change amount of a magnetic field strength of each set of magnets in the disk magnet, and a movement trajectory of the Hall sensor is parallel to and synchronized with a movement trajectory of the pivot center of the moving wheel; the apparatus includes a first determining module 601 and a second determining module 602, in which the first determining module 601 is configured to monitor the change amount of the magnetic field strength of each set of magnets in the disk magnet, and output N pulse waveforms according to the change amount of the magnetic field strength of each set of magnets, in which a value of N is associated with a rotation arc of the moving wheel, and N is a positive number, and the second determining module 602 is configured to determine a rotation arc of the disk magnet according to the N pulse waveforms, and determine a moving distance of the moving wheel according to the rotation arc of the disk magnet.

In some embodiments, the second determining module 602 is specifically configured to determine a rotation direction of the moving wheel according to a voltage value corresponding to the N pulse waveforms, in which the rotation direction includes a forward rotation direction and a reverse rotation direction; determine a first rotation arc when the moving wheel rotates in the forward rotation direction and a second rotation arc when the moving wheel rotates in the reverse rotation direction; add the first rotation arc to the second rotation arc to obtain a result and take the result as the rotation arc of the moving wheel.

In some embodiments, the second determining module 602 is specifically configured to inquire a stored correspondence relationship between pulse waveforms and rotation arcs according to the N pulse waveforms and determine the first rotation arc corresponding to a pulse waveform generated when the moving wheel rotates in the forward rotation direction and the second rotation arc corresponding to a pulse waveform generated when the moving wheel rotates in the reverse rotation direction in the N pulse waveforms.

In some embodiments, the second determining module 602 is further configured to determine the number of sets of the magnets and determine the correspondence relationship between the pulse waveforms and the rotation arcs according to the number of sets of the magnets.

In some embodiments, the second determining module 602 is specifically configured to determine a radius of the moving wheel, and determine the moving distance of the moving wheel according to the radius of the moving wheel and the rotation arc of the disk magnet.

In order to realize the method according to embodiments of the present disclosure, embodiments of the present disclosure provide a device for detecting a moving distance, applied to an automatic cleaning device. Specifically, as shown in FIG. 7, the device 70 includes: a processor 701 and a memory 702 having stored therein computer programs executable on the processor, in which when the computer programs are executed by the processor 701, the processor 701 is configured to:

monitor the change amount of the magnetic field strength of each set of magnets in the disk magnet, and output N pulse waveforms according to the change amount of the magnetic field strength of each set of magnets, in which a value of N is associated with a rotation arc of the moving wheel, and N is a positive number,

determine a rotation arc of the disk magnet according to the N pulse waveforms, and

determine a moving distance of the moving wheel according to the rotation arc of the disk magnet.

In an embodiment of the present disclosure, when the computer programs are executed by the processor 701, the processor 701 is configured to:

determine a rotation direction of the moving wheel according to a voltage value corresponding to the N pulse waveforms, in which the rotation direction includes a forward rotation direction and a reverse rotation direction;

determine a first rotation arc when the moving wheel rotates in the forward rotation direction and a second rotation arc when the moving wheel rotates in the reverse rotation direction;

add the first rotation arc to the second rotation arc to obtain a result and take the result as the rotation arc of the moving wheel.

In an embodiment of the present disclosure, when the computer programs are executed by the processor 701, the processor 701 is configured to inquire a stored correspondence relationship between pulse waveforms and rotation arcs according to the N pulse waveforms and determine the first rotation arc corresponding to a pulse waveform generated when the moving wheel rotates in the forward rotation direction and the second rotation arc corresponding to a pulse waveform generated when the moving wheel rotates in the reverse rotation direction in the N pulse waveforms.

In an embodiment of the present disclosure, when the computer programs are executed by the processor 701, the processor 701 is configured to determine the number of sets of the magnets and determine the correspondence relationship between the pulse waveforms and the rotation arcs according to the number of sets of the magnets

In an embodiment of the present disclosure, when the computer programs are executed by the processor 701, the processor 701 is configured to determine a radius of the moving wheel, and determine the moving distance of the moving wheel according to the radius of the moving wheel and the rotation arc of the disk magnet.

It should be noted that the device for detecting the moving distance provided in the above embodiments are constituted in the same principle of the method for detecting the moving distance, and the specific implementation process may refer to the method embodiments and thus details are not described here again.

In actual practices, as shown in FIG. 7, the device 70 may further include: at least one network interface 703. The various components in the device 70 for detecting the moving distance are coupled together by a bus system 704. It should be understood that bus system 704 is configured to realize connection communication among these components. The bus system 704 includes a date bus, a power bus, a control bus and a status signal bus. For clarity of description, various buses are labeled as the bus system 704 shown in FIG. 7. Specifically, the number of the processors 704 may be at least one. The network interface 703 is configured to communicate the device 70 for detecting the moving distance with other devices in a wire or wireless manner. The memory 702 in the embodiment of the present disclosure is configured to store various types of data to support the operation of the device 70.

The method described in the above embodiments of the present disclosure may be applied to the processor 701 or realized by the processor 701. The processor 701 may be an integrated circuit chip with a signal processing capability. In the implementation process, each step of the method described above may be realized by an integrated logic circuit of the hardware in the processor 701 or an instruction in a form of the software. The processor 701 described above may be a general purpose processor, a digital signal processor (DSP) or other programmable logic devices, discrete gate or transistor logic, discrete hardware components or the like. The processor 701 is configured to perform the methods, steps, and logic blocks disclosed in the embodiments of the present disclosure. The general purpose processor may be a microprocessor or any other conventional processor. The steps of the method disclosed in the embodiment of the present disclosure may be directly realized by the hardware of a decoding processor or a combination of hardware and software modules in the decoding processor. The software module may be in a storage medium, which is provided in a memory 702, and processor 701 reads information stored in the memory 702, in conjunction with the hardware, to perform the steps of the above method.

In an exemplary embodiment, the device 70 for detecting the moving distance may be realized by one or more application specific integrated circuits (ASICs), DSPs, programmable logic devices (PLDs), complex programmable logic devices (CPLDs), field-programmable gate arrays (FPGAs), general purpose processors, controllers, micro controller units (MCUs), microprocessors, or other electronic components to perform the aforementioned methods.

Specifically, embodiments of the present disclosure provide a computer-readable storage medium having stored therein computer programs that, when executed by a processor, cause the processor to:

monitor the change amount of the magnetic field strength of each set of magnets in the disk magnet, and output N pulse waveforms according to the change amount of the magnetic field strength of each set of magnets, in which a value of N is associated with a rotation arc of the moving wheel, and N is a positive number,

determine a rotation arc of the disk magnet according to the N pulse waveforms, and

determine a moving distance of the moving wheel according to the rotation arc of the disk magnet.

In an embodiment of the present disclosure, when the computer programs are executed by the processor, the processor is configured to:

determine a rotation direction of the moving wheel according to a voltage value corresponding to the N pulse waveforms, in which the rotation direction includes a forward rotation direction and a reverse rotation direction;

determine a first rotation arc when the moving wheel rotates in the forward rotation direction and a second rotation arc when the moving wheel rotates in the reverse rotation direction;

add the first rotation arc to the second rotation arc to obtain a result and take the result as the rotation arc of the moving wheel.

In an embodiment of the present disclosure, when the computer programs are executed by the processor, the processor is configured to inquire a stored correspondence relationship between pulse waveforms and rotation arcs according to the N pulse waveforms and determine the first rotation arc corresponding to a pulse waveform generated when the moving wheel rotates in the forward rotation direction and the second rotation arc corresponding to a pulse waveform generated when the moving wheel rotates in the reverse rotation direction in the N pulse waveforms.

In an embodiment of the present disclosure, when the computer programs are executed by the processor, the processor is configured to determine the number of sets of the magnets and determine the correspondence relationship between the pulse waveforms and the rotation arcs according to the number of sets of the magnets

In an embodiment of the present disclosure, when the computer programs are executed by the processor, the processor is configured to determine a radius of the moving wheel, and determine the moving distance of the moving wheel according to the radius of the moving wheel and the rotation arc of the disk magnet.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure, and thus should be included in the scope of the present disclosure.

1. A method for detecting a moving distance, applied to an automatic cleaning device comprising a moving wheel, wherein
the moving wheel comprises a disk magnet disposed at a pivot center of the moving wheel and configured to rotate along with the moving wheel;
the disk magnet comprises at least one set of magnets, each set of magnets having two corresponding poles; and
the moving wheel further comprises a Hall sensor configured to monitor a change amount of a magnetic field strength of each set of magnets in the disk magnet, wherein a movement trajectory of the Hall sensor is parallel to and synchronized with a movement trajectory of the pivot center of the moving wheel; and, wherein
the method comprises:
monitoring the change amount of the magnetic field strength of each set of magnets in the disk magnet;
outputting N pulse waveforms according to the change amount of the magnetic field strength of each set of magnets, wherein a value of N is associated with a rotation arc of the moving wheel, and N is a positive number,
determining a rotation direction of the moving wheel according to a voltage value corresponding to the N pulse waveforms, wherein the rotation direction comprises a forward rotation direction and a reverse rotation direction;
determining a rotation arc of the disk magnet according to the N pulse waveforms, and
determining a moving distance of the moving wheel according to the rotation arc of the disk magnet;
wherein determining the rotation arc of the disk magnet according to the N pulse waveforms comprises:
determining a first rotation arc when the moving wheel rotates in the forward rotation direction and a second rotation arc when the moving wheel rotates in the reverse rotation direction; and
combining the first rotation arc with the second rotation arc to obtain a result and taking the result as the rotation arc of the moving wheel.

2. (canceled)

3. The method according to claim 1, wherein determining the first rotation arc when the moving wheel rotates in the forward rotation direction and the second rotation arc when the moving wheel rotates in the reverse rotation direction comprises:
inquiring a stored correspondence relationship between pulse waveforms and rotation arcs according to the N pulse waveforms and determining the first rotation arc corresponding to a pulse waveform generated when the moving wheel rotates in the forward rotation direction and the second rotation arc corresponding to a pulse waveform generated when the moving wheel rotates in the reverse rotation direction in the N pulse waveforms.

4. The method according to claim 3, wherein before inquiring a stored correspondence relationship between pulse waveforms and rotation arcs according to the N pulse waveforms, the method further comprises:
determining a set quantity value for the magnets, and determining a relationship between the pulse waveforms and the rotation arcs according to the determined the set quantity value.

5. The method according to claim 1, wherein determining the moving distance of the moving wheel according to the rotation arc of the disk magnet comprises:
determining a radius of the moving wheel, and determining the moving distance of the moving wheel according to the radius of the moving wheel and the rotation arc of the disk magnet.

6. An apparatus for detecting a moving distance, applied to an automatic cleaning device comprising a moving wheel, wherein
the moving wheel comprises a disk magnet disposed at a pivot center of the moving wheel and configured to rotate along with the moving wheel;
the disk magnet comprises at least one set of magnets, each set of magnets having two corresponding poles;
the moving wheel further comprises a Hall sensor configured to monitor a change amount of a magnetic field strength of each set of magnets in the disk magnet, and a movement trajectory of the Hall sensor is parallel to and synchronized with a movement trajectory of the pivot center of the moving wheel;
the apparatus comprises a first determining module and a second determining module, wherein
the first determining module is configured to monitor the change amount of the magnetic field strength of each set of magnets in the disk magnet, and output N pulse waveforms according to the change amount of the magnetic field strength of each set of magnets, wherein a value of N is associated with a rotation arc of the moving wheel, and N is a positive number, and
the second determining module is configured to determine a rotation direction of the moving wheel according to a voltage value corresponding to the N pulse waveforms, wherein the rotation direction comprises a forward rotation direction and a reverse rotation direction; determine a first rotation arc when the moving wheel rotates in the forward rotation direction and a second rotation arc when the moving wheel rotates in the reverse rotation direction, combine the first rotation arc with the second rotation arc to obtain a result and take the result as the rotation arc of the moving wheel; and determine a moving distance of the moving wheel according to the rotation arc of the disk magnet.

7. (canceled)

8. The apparatus according to claim 6, wherein the second determining module is configured to inquire a stored correspondence relationship between pulse waveforms and rotation arcs according to the N pulse waveforms and determine the first rotation arc corresponding to a pulse waveform generated when the moving wheel rotates in the forward rotation direction and the second rotation arc corresponding to a pulse waveform generated when the moving wheel rotates in the reverse rotation direction in the N pulse waveforms.

9. The apparatus according to claim 6, wherein the second determining module is further configured to determine the number of sets of the magnets and determine the correspondence relationship between the pulse waveforms and the rotation arcs according to the number of sets of the magnets.

10. The method according to claim 6, wherein the second determining module is configured to determine a radius of the moving wheel, and determine the moving distance of the moving wheel according to the radius of the moving wheel and the rotation arc of the disk magnet.

11. A non-transitory computer-readable medium having stored therein computer programs that, when executed by a processor, cause the processor to perform a method for detecting a moving distance, applied to an automatic cleaning device comprising a moving wheel, wherein the moving wheel comprises a disk magnet disposed at a pivot center of the moving wheel and configured to rotate along with the moving wheel, wherein
the disk magnet comprises at least one set of magnets, each set of magnets having two corresponding poles; and
the moving wheel further comprises a Hall sensor configured to monitor a change amount of a magnetic field strength of each set of magnets in the disk magnet, and a movement trajectory of the Hall sensor is parallel to and synchronized with a movement trajectory of the pivot center of the moving wheel; and, wherein
the method comprises:
monitoring the change amount of the magnetic field strength of each set of magnets in the disk magnet;
outputting N pulse waveforms according to the change amount of the magnetic field strength of each set of magnets, wherein a value of N is associated with a rotation arc of the moving wheel, and N is a positive number,
determining a rotation direction of the moving wheel according to a voltage value corresponding to the N pulse waveforms, wherein the rotation direction comprises a forward rotation direction and a reverse rotation direction;
determining a rotation arc of the disk magnet according to the N pulse waveforms, and
determining a moving distance of the moving wheel according to the rotation arc of the disk magnet;
wherein determining the rotation arc of the disk magnet according to the N pulse waveforms comprises:
determining a first rotation arc when the moving wheel rotates in the forward rotation direction and a second rotation arc when the moving wheel rotates in the reverse rotation direction; and
combining the first rotation arc with the second rotation arc to obtain a result and taking the result as the rotation arc of the moving wheel.

12. (canceled)

13. The non-transitory computer-readable medium of claim 11,
wherein determining the first rotation arc when the moving wheel rotates in the forward rotation direction and the second rotation arc when the moving wheel rotates in the reverse rotation direction comprises:
inquiring a stored correspondence relationship between pulse waveforms and rotation arcs according to the N pulse waveforms and determining the first rotation arc corresponding to a pulse waveform generated when the moving wheel rotates in the forward rotation direction and the second rotation arc corresponding to a pulse waveform generated when the moving wheel rotates in the reverse rotation direction in the N pulse waveforms.

14. The non-transitory computer-readable medium of claim 13, wherein before inquiring a stored correspondence relationship between pulse waveforms and rotation arcs according to the N pulse waveforms, the method further comprises:
determining a set quantity value for the magnets, and determining a relationship between the pulse waveforms and the rotation arcs according to the determined the set quantity value.

15. The non-transitory computer-readable medium of claim 11,
wherein determining the moving distance of the moving wheel according to the rotation arc of the disk magnet comprises:
determining a radius of the moving wheel, and determining the moving distance of the moving wheel according to the radius of the moving wheel and the rotation arc of the disk magnet.

16. The method according to claim 1, wherein determining a rotation direction of the moving wheel is performed according to a voltage value corresponding to the N pulse waveforms.

17. The method according to claim 1, wherein determining a rotation direction of the moving wheel is performed relative to a driving instruction sent by a processor to control the rotation direction of the moving wheel.

18. The method according to claim 1, further comprises determining a switching point of the forward rotation direction and the reverse rotation direction.

19. The method according to claim 18, wherein determining a switching point of the forward rotation direction and the reverse rotation direction comprises:
inputting the magnetic field strengths detected by the Hall sensor into the processor;
performing, by a processor, digital-to-analog conversion on the magnetic field strengths;
acquiring a pulse waveform;
determining a current voltage value (VA) and a voltage value one second before (VB) based on the pulse waveform;
obtaining a product by multiplying VA and VB; and
determining the switching point if the product is less than or equal to zero.
